(19) United States
(12) Patent Application Publication
(10) Pub. No.: US 2026/0034542 A1
(43) Pub. Date: Feb. 5, 2026

(54) CENTRIFUGABLE SAMPLE CARRIER

(71) Applicant: Testo bioAnalytics GmbH, Titisee-Neustadt (DE)

(72) Inventors: Markus MÜNZER, Blumberg (DE); Marco NEIDHART, Lenzkirch (DE)

(73) Assignee: Testo bioAnalytics GmbH, Titisee-Neustadt (DE)

(21) Appl. No.: 19/286,424

(22) Filed: Jul. 31, 2025

(30) Foreign Application Priority Data
Aug. 5, 2024 (EP) 24192878.7

(51) Int. Cl. B01L 3/00

(52) U.S. Cl. CPC B01L 3/502; B01L 2200/0689; B01L 2200/16; B01L 2300/044; B01L 2300/047; B01L 2300/0832; B01L 2300/123; B01L 2400/0409

(57) ABSTRACT

A centrifugable sample carrier (1) is provided having a liquid reservoir (2) which is closed with a sealing film (7). The sample carrier (1) has at least one deformable region (8), and the liquid reservoir (2) is openable by a deformation of the deformable region (8). The deformable region (8) has at least one activation element (10), which pierces the sealing film (7) in the event of a deformation of the deformable region (8).

### CROSS-REFERENCE TO RELATED APPLICATIONS

This application claims priority from European Patent Application No. 24192878.7, filed Aug. 5, 2024, which is incorporated herein by reference as if fully set forth.

### TECHNICAL FIELD

The invention relates to a centrifugable sample carrier having a liquid reservoir which is closed with a sealing film.

### BACKGROUND

Centrifugable sample carriers having a fluidic system are known from the prior art and are often referred to as a “lab-on-a-chip” system, as they are used to identify and analyze microparticles in the smallest space. Such “lab-on-a-chip” systems are used, for example, in the food industry, in medicine and in pharmaceutical production.

Centrifugable sample carriers having a fluidic system often also have a liquid reservoir which, for example, holds a reagent that is required for an analysis. This liquid reservoir is initially tightly closed and is opened only during the analysis, as a result of which the liquid reservoir is connected to the fluidic system.

However, opening the liquid reservoir can result in uncontrolled emptying of the liquid reservoir and thereby possibly in the liquid escaping from the sample carrier. This is in any case undesirable.

### SUMMARY

It is therefore an object of the invention to improve a centrifugable sample carrier having a liquid reservoir.

The object is achieved by a sample carrier having one or more of the features disclosed herein.

The sample carrier according to the invention is therefore characterized in that the sample carrier has at least two activation elements, in that the activation elements are arranged adjacent to the sealing film, and in that the sealing film is pierceable by a movement of the activation elements.

The sealing film is usually thin in relation to a wall of the sample carrier. Piercing the sealing film therefore requires little force. In addition, the activation element can be pointed or tapered, whereby the activation element can pierce the sealing film even more easily.

The fact that the activation element is part of the sample carrier prevents contamination of the liquid and contamination of the activation element.

Between the activation element and the sealing film, a kind of chamber can be formed which can prevent escape of the liquid from the sample carrier.

In one embodiment, the liquid reservoir is arranged in such a way that, in the position of use of the sample carrier, an opening closed with the sealing film is oriented upward, i.e. counter to the force of gravity.

In this way, in the position of use, no liquid can escape from the liquid reservoir even when the sealing film is fully opened. Removal of the liquid is effected solely by the centrifugal force that occurs during centrifugation.

This centrifugal force presses the liquid in the liquid reservoir outward to an opening in the sealing film pierced by the activation element.

A further advantage is that the liquid reservoir can be opened at any time during an analysis process deliberately and independently of centrifugation. For example, a centrifugation step can thus take place even before the liquid reservoir is opened.

In this arrangement, the activation elements are arranged at the top in the position of use, i.e. above the sealing film, and the activation element is directed downward.

An activation element can be formed by a wall of the sample carrier. An activation element can be designed, for example, as a bending tongue or an otherwise elastically deformable element, also as part of a wall. The activation element is preferably formed in one piece with the sample carrier.

In one embodiment, an air space is formed below the sealing film in the position of use of the sample carrier. This means that the liquid in the liquid reservoir does not lie on the sealing film in the position of use. Therefore, when piercing the sealing film, the activation elements always meet the air space and not the liquid. An uncontrolled release of the liquid can additionally be prevented in this way.

In one embodiment, the liquid reservoir is designed as a blister. This allows the liquid reservoir to be easily manufactured and filled, for example before it is placed in a sample carrier. This makes it possible to equip a sample carrier with, for example, different reagents depending on the requirements and the application. The blister can therefore be filled outside the sample carrier and closed with sealing film.

Alternatively, the liquid reservoir can also be formed, for example, in one piece with the sample carrier. It can then be filled, for example, using a pipetting machine and then closed with sealing film. Further embodiments of the liquid reservoir are conceivable, which cannot all be listed here, and therefore the application is not in any way intended to be limited to a particular embodiment of the liquid reservoir.

In one embodiment, the liquid reservoir has a round circumferential contour. In this way, it is particularly easy to arrange a possibly filled blister on the sample carrier, since no orientation has to be observed.

In one embodiment, the liquid reservoir has a frustoconical shape, wherein preferably the end closed with sealing film has the larger diameter. The liquid reservoir can also have a spherical shape or at least form a partial sphere. As a result, the liquid reservoir has chamfered walls, so that the liquid can be more easily pressed by the centrifugal force to an opening in the sealing film. In this way, it can also be achieved that the liquid reservoir is completely emptied, since no liquid can accumulate in corners. Of course, other shapes for the liquid reservoir are also conceivable and feasible.

In one embodiment, the sample carrier has at least one fluid channel, which is connectable to the liquid reservoir. In this way, the liquid reservoir can be connected to a fluidic system of the sample carrier. In particular, for example, the abovementioned chamber can be connected to the fluidic system by an opening or a channel.

In one embodiment, the activation elements can be subjected to pressure by a stamp. In this way, it is possible, for example, to open the liquid reservoir mechanically at a desired time in the position of use. For example, the stamp can be driven by an electric actuator.

In one embodiment, the activation elements are designed elastically and return to their original shape after application of pressure. This can ensure that an opening in the sealing film is freed, and thus actually opened, by the pulling-out of the activation element.

Preferably, the at least one activation element is arranged substantially on the outer circumference of the liquid reservoir, so that the liquid reservoir can be pierced at its outer circumference. This makes it easier to empty the liquid reservoir by the centrifugal force. This is because the liquid, during centrifugation, is conveyed to the outer edge of the liquid reservoir by the centrifugal force. In this case, a beveled or curved wall can additionally be advantageous, in particular.

In one embodiment, the at least two activation elements are distributed, preferably regularly, at the circumference of the liquid reservoir. In this way, a (regular) perforation of the sealing film can be achieved. This facilitates the emptying of the liquid reservoir, since air can flow through the at least second opening of the sealing film into the liquid reservoir, according to the amount of liquid removed.

In one embodiment, at least one activation element is located at the lowest point of the centrifugation direction. The centrifugation direction thus points in the direction of the centrifugal force, and the lowest point is the point of the liquid reservoir farthest away from the centrifugation center in this centrifugation direction.

The invention further comprises a method for emptying a liquid reservoir of a centrifugable sample carrier, wherein a sealing film of the liquid reservoir is opened at at least two points spaced apart from each other, and a centrifugal force (Fg) is applied to the liquid in the liquid reservoir in order to drain the liquid. In one embodiment, the sample body is a sample body according to the invention.

In one embodiment, at least one of the openings is applied at the lowest point of the centrifugation direction. In this way, complete and clean emptying of the liquid reservoir within the sample body is possible. This is because the centrifugal force conveys the liquid to this lowest point, where it can escape from the liquid reservoir through the opening and can flow into a fluidic system of a sample carrier.

In one embodiment, the openings are each made by an activation element arranged on the sample body. In this way, contamination of the liquid can be avoided and clean and complete emptying can be ensured.

### BRIEF DESCRIPTION OF THE DRAWINGS

The invention is explained in more detail below on the basis of a preferred exemplary embodiment with reference to the appended drawings, in which:

FIG. 1 shows a schematic sectional view of a detail of a centrifugable sample body,

FIG. 2 shows the sample body of FIG. 1 in the position of use in a centrifuge with a stamp for activating the sample body,

FIG. 3 shows the sample body of FIG. 1 with the stamp lowered,

FIG. 4 shows the sample body of FIG. 1 with a perforated sealing film, after lifting of the stamp,

FIG. 5 shows the sample body of FIG. 1 during centrifugation,

FIG. 6 shows a schematic sectional view of a detail of a further centrifugable sample body, and

FIG. 7 shows the sample body of FIG. 6 with a perforated sealing film, after lifting of the stamps.

### DETAILED DESCRIPTION

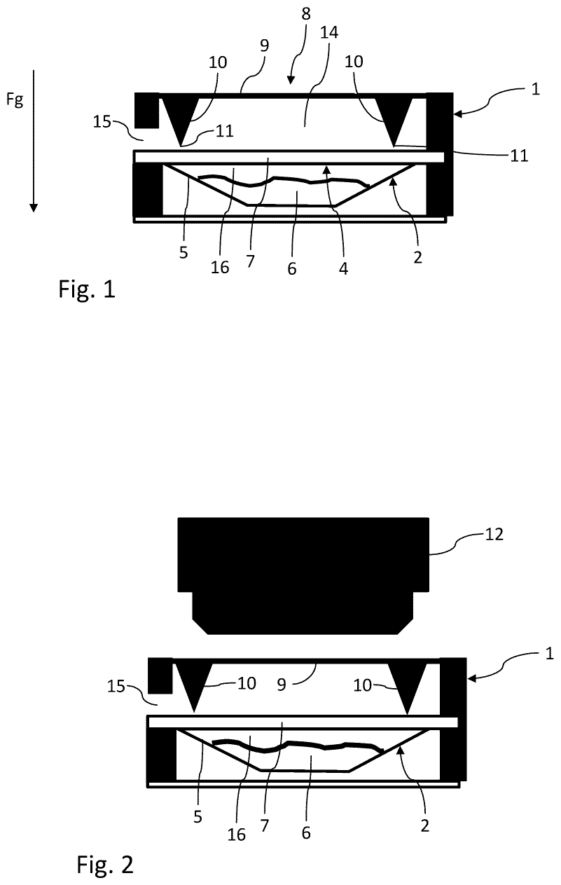

FIG. 1 schematically shows a sectional view of a detail of a centrifugable sample carrier 1. The sample carrier 1 has a fluidic system (not shown in detail) which is designed, for example, for a lab-on-a-chip. In addition, the sample carrier 1 has a receptacle for a centrifuge, whereby the sample carrier 1 can be held safely in a centrifuge. The fluidic system and the receptacle are not essential to the invention, and therefore their exact design is not shown and is also not relevant. Centrifugable sample carriers are, however, sufficiently known in the prior art, where the teaching according to the invention can be combined readily and directly with any sample carrier.

The sample carrier 1 is shown in FIG. 1 in the position of use. This means that it sits in the illustrated orientation in a centrifuge. In this orientation, the force of gravity Fg points downward.

In the embodiment shown, the liquid reservoir 2 is designed as a blister, which is subsequently insertable into a corresponding receptacle 3 in the sample carrier 1. The inserted liquid reservoir 2 is oriented such that an opening 4 of the liquid reservoir 2 is arranged at the top.

The opening 4 of the liquid reservoir 2 is closed with a sealing film 7. The liquid reservoir 2 in the example has a frustoconical shape, wherein the opening 4 has the larger diameter. The oblique walls 5 of the truncated cone therefore extend from the bottom diagonally upward. Within the liquid reservoir 2, a liquid 6 is shown. The liquid reservoir 2 in the example is about half the height of the sample body 1, the sealing film 7 being located approximately at the vertical center of the sample carrier. Of course, the liquid reservoir 2 can also have other dimensions.

Above the liquid reservoir 2, the sample carrier 1 has a deformable region 8. This deformable region is formed, for example, as a membrane 9 in one piece with the sample body 1. Two or more activation elements 10 are arranged on the underside of the membrane 9. The activation elements 10 are thus arranged between the membrane 9 and the sealing film 7 of the liquid reservoir 2. The activation elements 10 are shown here as triangles with a tip 11. For example, they can be designed as a cone with a round cross section. However, other forms are conceivable, with a tip 11 being advantageous.

In the position of use, however, the activation elements 10 do not touch the sealing film 7; the distance between the tips 11 of the activation elements 10 and the sealing film 7 in the position of use can be small, for example less than 1 mm, in particular less than 0.2 mm.

Between the sealing film 7 of the liquid reservoir 2 and the membrane, a chamber 14 is formed which is substantially liquid-tight. The chamber 14 is connected via a channel 15 to a fluidic system (not shown in any detail) of the sample carrier 1.

FIG. 2 shows the sample carrier inserted into a centrifuge (not shown in any detail) which has a stamp 12 for activating the sample carrier 1. The activation of the sample carrier 1 involves opening the liquid reservoir 2. The stamp is oriented above the deformable region 8.

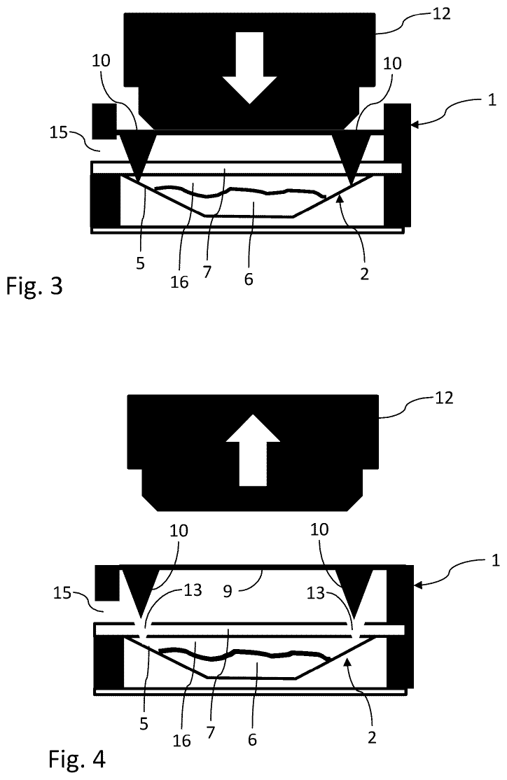

FIG. 3 shows the stamp lowered. The membrane 9 of the deformable region 8 is thereby deformed and the tips 11 of the activation elements 10 pierce the sealing film 7.

The activation elements 10 are arranged on the membrane 9 in such a way that they lie on the outer circumference of the liquid reservoir 2. The sealing film 7 is therefore pierced at the circumference of the opening 4 of the liquid reservoir 2.

The membrane 9 and the deformable region 8 are preferably elastically deformable, so that the membrane 9, after the stamp 12 is lifted, the membrane 9 returns to its original shape, as shown in FIG. 4.

Two holes 13 are left behind in the sealing film 7. Of course, the membrane 9 can also have more than two activation elements 10, as a result of which more than two holes 13 would then result in the sealing film 7.

The advantage of the invention is that the holes 13 in the sealing film 7 are at the top, i.e. counter to the force of gravity Fg. It is therefore impossible for the liquid 6 to escape from the liquid reservoir 2 independently or due to the force of gravity Fg.

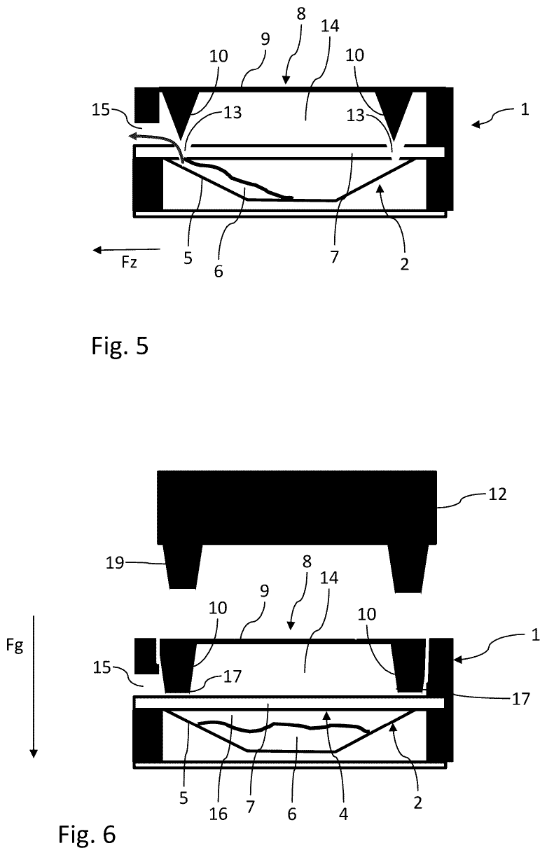

Removal of the liquid 6 can be effected exclusively by a centrifugal force Fz, which occurs, for example, during centrifugation of the sample carrier 1. FIG. 5 shows an example of this process. During a centrifugation of the sample carrier 1, a centrifugal force Fz acts on the liquid 6. The liquid 6 is pressed against an outer wall 5 of the liquid reservoir by the force Fz. Since this wall 5 runs obliquely outward and upward, the liquid 6 is pressed outward and upward along the wall. At the upper and outer end of the liquid reservoir 2, however, there is a hole 13 through which the liquid 6 can now flow out of the liquid reservoir 2 into the chamber 14. From there, the liquid 6 passes through the channel 15 into a fluidic system of the sample carrier. Through the inner hole 13 in the sealing film 7, air can flow into the liquid reservoir according to the amount of liquid removed, so that complete and simple emptying of the liquid reservoir 2 can take place.

The direction of the centrifugal force Fz also indicates the centrifugation direction. Advantageously, at least one activation element 10 is arranged at the lowest point of the centrifugation direction. This ensures that opening of the sealing film takes place at least at the point at which the liquid is pressed by the centrifugal force Fz. This prevents any residual liquid from forming in the liquid reservoir.

FIG. 6 schematically shows a sectional view of a section of a centrifugable sample carrier 1 according to an alternative embodiment. The sample carrier 1 largely corresponds to the sample carrier 1 of FIG. 1. Identical and/or functionally identical features are therefore provided with the same reference signs and are not explained in detail again.

The sample carrier 1 of FIG. 6 differs from the sample carrier 1 of FIG. 1 in terms of the design of the activation elements 10. The activation elements 10 in this embodiment have, instead of the tip, an elongate cutting edge 17 oriented in the centrifugation direction. In this embodiment, the cutting edge 17 protrudes beyond the outer edge of the liquid reservoir 2. This has the effect that the opening 13 extends completely to the edge of the liquid reservoir 2, and no pockets are formed behind which liquid 6 can accumulate. The cutting edge 17 deforms the walls 5 of the liquid reservoir 2 but does not puncture them. This prevents liquid from being able to escape downward, i.e. in the direction of gravity, from the liquid reservoir.

The activation elements 10 in this embodiment are each arranged at the free end 20 of a bending tongue 18. The stamp 12 here has two stamp projections 19, which are each arranged opposite a free end 20 of a bending tongue 18. As the stamp 12 is lowered, each stamp projection 19 deflects a bending tongue 18 so that the cutting edge 17 of the respective activation element 10 pierces the sealing film 7.

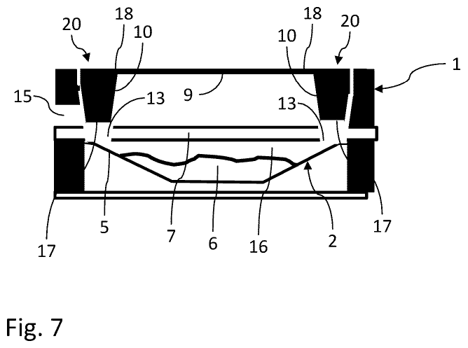

FIG. 7 shows the sample body 1 after the stamp 12 has been lowered and then lifted again. It can be seen clearly here that the openings 13 extend beyond the edge of the liquid reservoir 2, so that complete emptying of the liquid 6 is ensured.

### LIST OF REFERENCE SIGNS

1 sample carrier
2 liquid reservoir
3 receptacle
4 opening
5 walls
6 liquid
7 sealing film
8 deformable region
9 membrane
10 activation element
11 tip
12 stamp
13 hole
14 chamber
15 channel
16 air space
17 cutting edge of an activation element
18 bending tongue
19 stamp projection
20 free end of a bending tongue

1. A centrifugable sample carrier (1), comprising:
a liquid reservoir (2) which is closed with a sealing film (7); and
at least two activation elements (10), with the activation elements (10) arranged adjacent to the sealing film (7);
wherein the sealing film (7) is pierceable by a movement of the activation elements (10).

2. The sample carrier (1) as claimed in claim 1, wherein the liquid reservoir (2) is arranged such that, in a position of use of the sample carrier (1), at least one of a) an opening (4) of the liquid reservoir (2), closed with the sealing film (7), is oriented upward, counter to a direction of gravity (Fg), or b) an air space (16) is formed below the sealing film (7).

3. The sample carrier (1) as claimed in claim 1, wherein the liquid reservoir (2) is a blister.

4. The sample carrier (1) as claimed in claim 1, wherein the liquid reservoir (2) has at least one of a round circumferential contour, a hemispherical shape, or a frustoconical shape.

5. The sample carrier (1) as claimed in claim 1, further comprising at least one fluid channel (15), which is connectable to the liquid reservoir (2).

6. The sample carrier (1) as claimed in claim 1, wherein at least one of the at least two activation elements (10) is adapted to be subjected to pressure by a stamp (12).

7. The sample carrier (1) as claimed in claim 1, wherein the at least two activation elements (10) are elastic and have an original shape, and the activation elements (10) are adapted to return to the original shape after release of a pressure application.

8. The sample carrier (1) as claimed in claim 1, wherein the at least two activation elements (10) are arranged substantially on an outer circumference of the liquid reservoir (2), so that the liquid reservoir (2) is pierceable at the outer circumference.

9. The sample carrier (1) as claimed in claim 8, wherein at least one of the activation elements projects outward beyond an opening (4) of the liquid reservoir (2).

10. The sample carrier (1) as claimed in claim 1, wherein the at least two activation elements (10) are distributed on a circumference of the liquid reservoir (2).

11. The sample carrier (1) as claimed in claim 1, wherein at least one of the activation elements (10) is located at a lowest point of a centrifugation direction.

12. The sample carrier (1) as claimed in claim 1, wherein a liquid (6) in the liquid reservoir (2) is adapted to be conveyed out of the liquid reservoir (2) by centrifugal force (Fz).

13. A method for emptying a liquid reservoir of a centrifugable sample carrier, the method comprising:
opening a sealing film of a liquid reservoir at at least two points spaced apart from each other; and
applying a centrifugal force (Fg) to the liquid in the liquid reservoir in order to drain the liquid.

14. The method as claimed in claim 13, wherein the sample carrier includes the liquid reservoir (2) which is closed with the sealing film (7), and at least two activation elements (10), with the activation elements (10) arranged adjacent to the sealing film (7), and the opening of the sealing film (7) includes piercing the sealing film (7) by a movement of the activation elements (10).

15. The method as claimed in claim 14, wherein at least one of the openings is applied at a lowest point of the centrifugation direction.
